(19) United States
(12) Patent Application Publication
(10) Pub. No.: US 2024/0210227 A1
(43) Pub. Date: Jun. 27, 2024

(54) METHOD FOR OPERATING A CORIOLIS MEASURING DEVICE

(71) Applicant: Endress+Hauser Flowtec AG, Reinach (CH)

(72) Inventor: Hao Zhu, Freising (DE)

(21) Appl. No.: 17/906,831

(22) PCT Filed: Mar. 8, 2021
(86) PCT No.: PCT/EP2021/055737

§ 371 Date: Sep. 20, 2022

(30) Foreign Application Priority Data
Mar. 20, 2020 (DE) 10 2020 107 711.4

(51) Int. Cl. G01F 1/84

(52) U.S. Cl. CPC G01F 1/8436; G01F 1/8422; G01F 1/8427

(57) ABSTRACT

The present disclosure relates to method for operating a Coriolis measuring device, comprising the following method steps: determining an attenuation of the measuring tube vibrations in the region of the first vibration sensor and in the region of the second vibration sensor, measuring a first measurement variable by means of the measurement signals from the first vibration sensor and from the third vibration sensor, measuring a second mass flow rate by means of the measurement signals from the second vibration sensor and from the third vibration sensor, determining an influence of the attenuation on the first measurement variable and on the second measurement variable, forming differences between measured values of the first measurement variable and measured values of the second measurement variable, and comparing the differences with the determined attenuation of the measuring tube vibrations.

The invention relates to a method for operating a Coriolis measuring device in an interference-resistant manner.

Coriolis measuring devices with increased reliability are proposed in WO98/52000, in which, instead of two Coriolis sensors, an arrangement of three such sensors is taught for the purpose of sensing measuring tube vibrations. If one sensor fails, the operation of the Coriolis measuring device can thus be maintained with the remaining sensors.

However, not only mechanical failures affect the functioning of a Coriolis measuring device, but also disadvantageous environmental conditions such as local magnetic fields.

The object of the invention is therefore to propose a method for operating a Coriolis measuring device, by means of which interference can be detected.

The object is achieved by a method according to independent claim 1.

In a method according to the invention for operating a Coriolis measuring device for determining a mass flow and/or a density of a medium flowing through a pipeline, comprising:
at least one measuring tube with an inlet and an outlet, wherein the measuring tube is symmetrical with respect to a plane of symmetry extending through a measuring tube cross section;
at least one vibration exciter for generating measuring tube vibrations,
wherein the measuring tube is designed, when mass flows through, to form a Coriolis mode with a vibration node in the region of the plane of symmetry,
wherein the Coriolis measuring device has a first vibration sensor, a second vibration sensor and a third vibration sensor, which are designed to sense measuring tube vibrations, wherein the vibration sensors are each arranged at different locations along a measuring tube center line,
wherein the first vibration sensor is arranged on an inlet side of the measuring tube relative to the vibration node, and wherein the second vibration sensor is arranged on an outlet side of the measuring tube relative to the vibration node, and wherein the third vibration sensor is arranged in the region of the vibration node,
wherein the first vibration sensor and the second vibration sensor are arranged symmetrically with respect to the plane of symmetry,
the method comprises the following method steps:
determining an attenuation of the measuring tube vibrations,
measuring a first measurement variable by means of the measurement signals from the first vibration sensor and from the third vibration sensor,
measuring a second measurement variable by means of the measurement signals from the second vibration sensor and from the third vibration sensor,
determining an influence of the attenuation on the first measurement variable and on the second measurement variable and correcting measured values of the first measurement variable and measured values of the second measurement variable,
forming differences between measured values of the first measurement variable and measured values of the second measurement variable, so that an influence of the mass flow on the differences is canceled out,
checking a correspondence between the difference and the attenuation.

The listed method steps do not necessarily have to be carried out in the order shown here. The order is essentially linked to causality. For example, the measurement of the first measurement variable and of the second measurement variable can also take place simultaneously.

An essential point of the method is that measuring tube vibrations in the region of the first vibration sensor and in the region of the second vibration sensor are each attenuated or delayed relative to the vibration exciter by the medium. This can be attributed, for example, to a viscosity of the medium. When a measurement variable is measured by means of the first vibration sensor and the second vibration sensor by forming the difference between measurement signals from the vibration sensors or between measured values derived from the measurement signals, the contribution of the vibration attenuation or vibration delay no longer applies.

When a measurement variable is correspondingly measured by means of the first vibration sensor or second vibration sensor together with the third vibration sensor in each case, the contribution of the vibration attenuation in the case of suitable difference formation does not cease to apply, since the third vibration sensor strictly follows the movement of the vibration exciter. In this way, a direct measured value for the symmetrical vibration attenuation can be determined. In the absence of substantial interference, the direct measured value of the symmetrical vibration attenuation corresponds to the expected value of the attenuation or phase delay.

Correspondence can be determined, for example, by calculating an expected value for the difference between measured values of the first measurement variable and measured values of the second measurement variable from the attenuation and comparing it with the actual value of the difference, or by calculating an expected value for an attenuation from the difference and comparing it with the determined value of the attenuation.

In one embodiment, the vibration exciter can be designed as a third vibration sensor, wherein the vibration exciter is used as a vibration sensor intermittently, for example.

In one embodiment, a type of interference is determined if the differences deviate from the expected value, wherein the presence of a deviation of an asymmetry of measurement signals from the vibration sensors from a reference value is checked, wherein the check takes into account amplitudes of the measurement signals. A complete symmetry of the measurement signals from vibration sensors is only very rarely the case for practical reasons. Therefore, for example when the Coriolis measuring device is put into operation, a reference value is determined for an asymmetry, which describes an initial state of the Coriolis measuring device.

If a measurement signal amplitude of the first or second vibration sensor does not correspond to measuring signal amplitudes of the other vibration sensors, this is evaluated as the presence of an asymmetry. Such a correspondence can be decided, for example, by means of a limit value for the deviations. For example, if an amount of a deviation exceeds a limit value, this can be interpreted as lack of correspondence.

In one embodiment, when an asymmetry is present, a mass flow measurement is supported on an undisturbed pair of vibration sensors.

If a measurement signal amplitude of the first or second vibration sensor does not correspond to measuring signal amplitudes of the other vibration sensors, this can be evaluated as an indication of a malfunction or interference.

In one embodiment, the influence of the attenuation on measured values of the undisturbed first measurement variable or second measurement variable is corrected. In this way, a mass flow measurement on the basis of an undisturbed pair of vibration sensors can be performed with good accuracy.

In one embodiment, when determining the disturbed vibration sensor, a measurement signal amplitude of the third vibration sensor is taken into account in order to determine a plausibility of a measurement signal amplitude of the first vibration sensor and a measurement signal amplitude of the second vibration sensor.

In one embodiment, when the reference value of the deviation is present, a reduction in efficiency of the vibration exciter or of the vibration sensor is established from a measure of a non-correspondence between the difference and the attenuation and in particular compensated. The measure can be based on an absolute or relative deviation. The reduction in efficiency can be caused, for example, by aging of a magnet of the vibration exciter. The presence of the reference value can be defined by a maximum deviation. The person skilled in the art will choose a reasonable value without problems.

A non-correspondence can be determined by calculating an expected value for the difference from the attenuation and comparing it with the actual value of the difference. A non-correspondence can be determined by calculating an expected value for an attenuation from the difference and comparing it with the determined value of the attenuation.

In one embodiment, the attenuation is determined by a ratio of the excitation current of the vibration exciter to the specific vibration amplitude of a vibration sensor.

In one embodiment, the first measurement variable and the second measurement variable are each a phase difference or a measurement variable derived therefrom, such as a time difference or mass flow.

In one embodiment, if the deviation has a time constant less than one month and in particular less than one week, the interference is interpreted as being caused by an external magnetic field in the region of a vibration sensor.

In one embodiment, the vibration sensors and the vibration exciter each have a magnet system and a coil system, which magnet system and coil system are movable relative to one another in parallel with a vibration direction.

A magnet system comprises at least one magnet; a coil system comprises at least one coil.

In one embodiment, the Coriolis measuring device has an electronic measuring/operating circuit which operates the vibration exciter, evaluates measurement signals from the vibration sensors, carries out method steps, and calculates and provides measured values of measurement variables of the Coriolis measuring device.

In one embodiment, a warning message is output if the differences deviate from the expected value.

The invention will now be described with reference to exemplary embodiments.

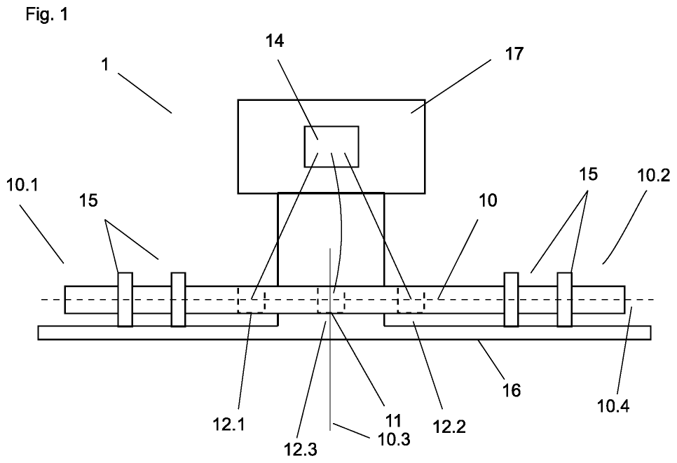

FIG. 1 illustrates an exemplary Coriolis measuring device according to the invention;

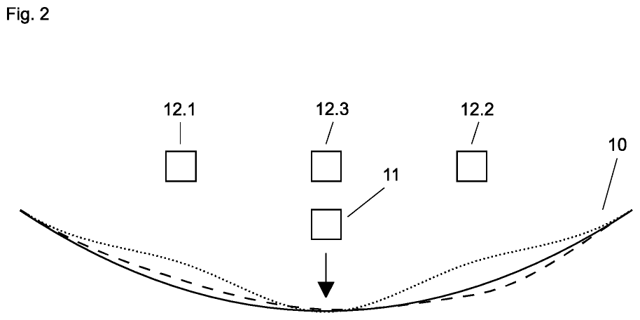

FIG. 2 illustrates influences on a measuring tube vibration;

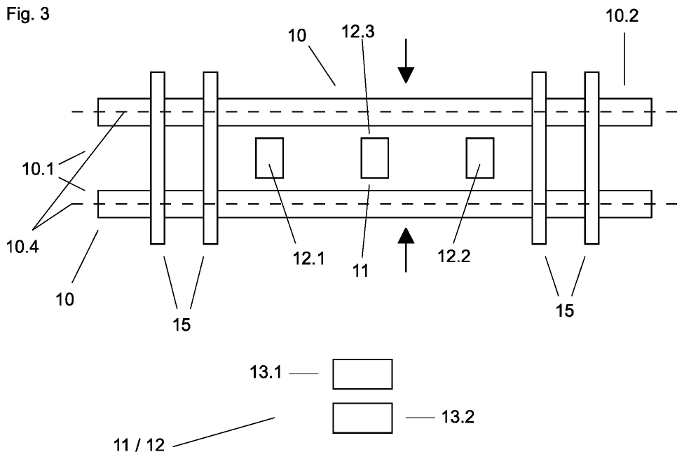

FIG. 3 illustrates an exemplary pair of measuring tubes;

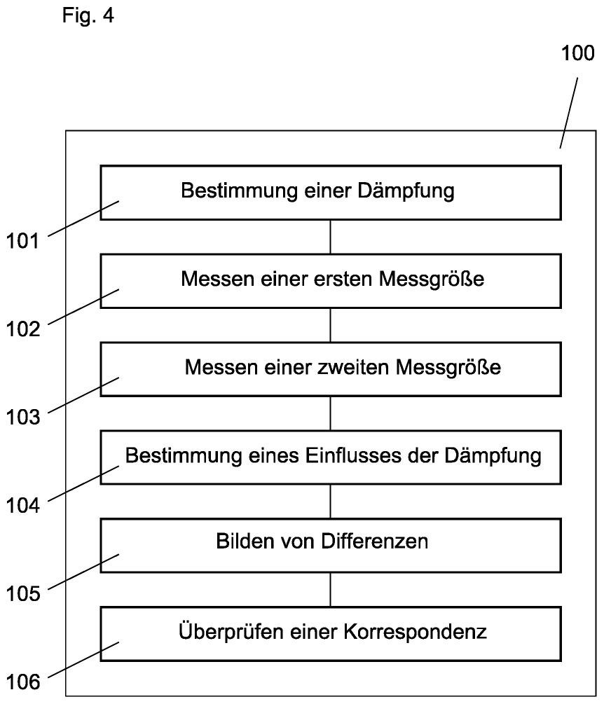

FIG. 4 illustrates a sequence of an exemplary method according to the invention.

FIG. 1 illustrates a side view of an exemplary Coriolis measuring device 1 with two measuring tubes 10, fixing elements 15, a supporting element 16 for supporting the measuring tubes, an electronic measuring/operating circuit 14 for operating the exciter and for sensing measurement signals generated by the sensors and for providing measured values of the density or mass flow, and a housing 17 for housing the electronic measuring/operating circuit. Vibration exciter 11 and vibration sensors 12 are shown with dashed lines, since they are arranged between the measuring tubes. Fixing elements 15 are designed to define vibration nodes of measuring tube vibrations; they are known to the person skilled in the art. The number and design of such fixing elements will be configured by the person skilled in the art according to their needs.

The Coriolis measuring device has a first vibration sensor 12.1 on the inlet side, a second vibration sensor 12.2 on the outlet side, and a third vibration sensor 12.3, wherein the third vibration sensor is arranged between the first vibration sensor and the second vibration sensor with respect to a measuring tube center line 10.4 at the height of the vibration exciter 11. The third vibration sensor thus senses the vibration movement generated by the vibration exciter. In this case, the measuring tubes are each symmetrical with respect to a plane of symmetry 10.3 extending in each case through a measuring tube cross section, to form a reflection at the plane of symmetry.

Coriolis measuring devices are limited neither to two measuring tubes nor to straight measuring tubes. Coriolis measuring devices can have any number of measuring tubes, in particular also only one measuring tube or 4 measuring tubes. The measuring tubes can also be arcuate.

FIG. 2 illustrates various influences on a measuring tube vibration. The arrangement of the vibration sensors 12.1 to 12.3 and of the vibration exciter 11 in the graphic are purely schematic and merely serve to illustrate the positioning along a measuring tube center line.

The solid line corresponds to an idealized measuring tube deformation without a Coriolis effect, without an attenuation effect and with only a schematic consideration of an edge fixation.

The Coriolis effect occurring in a mass flow through the measuring tube causes a deformation of the measuring tube vibration as shown by the dashed line. For example, the Coriolis effect causes trailing of the measuring tube vibration on the inlet side in the region of the first vibration sensor and then causes leading of the measuring tube vibration on the outlet side in the region of the second vibration sensor, relative to a measuring tube vibration without a Coriolis effect. This can be sensed by determining measurement signal phases of the vibration sensors. For example, formation of a difference between measurement signal phases can be used to measure the Coriolis effect and thus to determine mass flow.

A vibration attenuation caused, for example, by a viscosity of the medium causes trailing at the first vibration sensor and at the second vibration sensor relative to the third vibration sensor or vibration exciter. This phenomenon is called symmetrical vibration attenuation. If a vibration-attenuating effect of the medium or the viscosity is known, an expected value of the trailing or the corresponding phase delay or the corresponding attenuation can be determined. In this case, a ratio of the excitation current of the vibration exciter to the specific vibration amplitude of a vibration sensor is determined.

By measuring a first measurement variable by means of the measurement signals from the first vibration sensor and from the third vibration sensor, and measuring a second measurement variable by means of the measurement signals from the second vibration sensor and from the third vibration sensor, and forming the difference between measured values of the first measurement variable and measured values of the second measurement variable, so that influences due to the mass flow cancel each other out, without interference of the vibration, only the influence of the symmetrical vibration attenuation remains. In order to cancel out the influence of the mass flow and to amplify the symmetrical vibration attenuation, for example in the event that the first measurement variable and the second measurement variable are differences of measurement signals from the vibration sensors, a difference between the first measurement variable and the second measurement variable can be formed. For example, the first measurement variable can be a phase difference between the first vibration sensor 12.1 and the third vibration sensor 12.3, and the second measurement variable can be a phase difference between the third vibration sensor 12.3 and the second vibration sensor 12.2. A formation of the difference between the first measurement variable and the second measurement variable then corresponds to the sum of the phases of the first vibration sensor and the second vibration sensor minus twice the phase of the third vibration sensor. Instead of a phase difference, a measurement variable derived therefrom, such as a time difference or mass flow, can also be used. In this way, a direct measured value for the symmetrical vibration attenuation can be determined. In the absence of substantial interference, the direct measured value of the symmetrical vibration attenuation corresponds to the expected value of the attenuation or phase delay.

If the direct measured value and the expected value do not correspond, this can be evaluated as the presence of interference. This can be caused, for example, by a measurement signal distortion of the first vibration sensor or of the second vibration sensor by an external magnetic field. However, an aging of a magnet of the first vibration sensor or of the second vibration sensor or of the vibration exciter can also be present, for example.

FIG. 3 illustrates an exemplary pair of measuring tubes 10 of a Coriolis measuring device according to the invention with a first vibration sensor 12.1, a second vibration sensor 12.2, a third vibration sensor 12.3 and a vibration exciter 11, wherein the third vibration sensor and the vibration exciter are arranged at the same position with respect to the measuring tube center lines 10.4. The vibration exciter is designed to cause the measuring tubes of the measuring tube pair to vibrate against each other. In this way, forces arising in the measuring tubes cancel each other out, and low-vibration operation is made possible. As indicated here, the vibration sensors and the vibration exciter can each have a coil system 13.2 and a magnet system 13.1, which are movable relative to one another and are designed to interact electromagnetically. For example, the coil system can be arranged on a first measuring tube and follow the vibration movements thereof, and the magnet system can be arranged on a second measuring tube and follow the vibration movements thereof. During vibration excitation, a force is exerted on the associated magnet system by means of a coil current. During vibration detection, the relative movement causes electromagnetic induction in the coil system, which can be used as a measurement signal. Possible arrangements and embodiments of vibration sensors and vibration exciters relative to the at least one measuring tube are known to the person skilled in the art.

FIG. 4 illustrates the sequence of an exemplary method according to the invention.

The method 100 comprises the following method steps:

In a method step 101, attenuation of the measuring tube vibrations is determined,

In a method step 102, a first measurement variable is measured by means of the measurement signals from the first vibration sensor and from the third vibration sensor,

In a method step 103, a second measurement variable is measured by means of the measurement signals from the second vibration sensor and from the third vibration sensor,

In a method step 104, an influence of the attenuation on the first measurement variable and on the second measurement variable is determined,

In a method step 105, differences between measured values of the first measurement variable and measured values of the second measurement variable are formed,

In a method step 106, the differences are compared with an expected value derived from the attenuation.

The listed method steps do not necessarily have to be carried out in the order shown here. The order is essentially linked to causality.

An essential point of the method is that measuring tube vibrations in the region of the first vibration sensor and in the region of the second vibration sensor are each attenuated or delayed relative to the vibration exciter by the medium. This can be attributed, for example, to a viscosity of the medium. When a measurement variable is measured by means of the first vibration sensor and the second vibration sensor by forming the difference between measurement signals from the vibration sensors or between measured values derived from the measurement signals, the contribution of the vibration attenuation or vibration delay no longer applies. When a measurement variable is correspondingly measured by means of the first vibration sensor or second vibration sensor together with the third vibration sensor in each case, the contribution of the vibration attenuation does not cease to apply, since the third vibration sensor strictly follows the movement of the vibration exciter. In this regard, see also FIG. 2. If the attenuation is known, an expected value of the delay or attenuation in the region of the first vibration sensor and in the region of the second vibration sensor can be determined. The expected value of the attenuation can be determined via the ratio of the excitation current of the vibration exciter to the specific vibration amplitude of a vibration sensor.

### LIST OF REFERENCE SIGNS

1 Coriolis measuring device
10 Measuring tube
10.1 Inlet
10.2 Outlet
10.3 Plane of symmetry
10.4 Measuring tube center line
11 Vibration exciter
12.1 First vibration sensor
12.2 Second vibration sensor
12.3 Third vibration sensor
13.1 Magnet system
13.2 Coil system
14 Electronic measuring/operating circuit
15 Fixing element
16 Supporting element
17 Housing
100 Method
101 Determine an attenuation
102 Measure a first measurement variable
103 Measure a second measurement variable
104 Determine an influence of the attenuation
105 Form differences
106 Compare the differences

1-12. (canceled)

13. A method for operating a Coriolis measuring device for determining a mass flow and/or a density of a medium flowing through a pipeline, comprising:
at least one measuring tube with an inlet and an outlet, wherein the measuring tube is symmetrical with respect to a plane of symmetry extending through a measuring tube cross section;
at least one vibration exciter for generating measuring tube vibrations,
wherein the measuring tube, when medium flows through, forms a Coriolis measuring device with a vibration node in the region of the plane of symmetry,
wherein the Coriolis measuring device has a first vibration sensor, a second vibration sensor and a third vibration sensor, which are designed to sense measuring tube vibrations, wherein the vibration sensors are each arranged at different locations along a measuring tube center line,
wherein the first vibration sensor is arranged on an inlet side of the measuring tube relative to the vibration node, and wherein the second vibration sensor is arranged on an outlet side of the measuring tube relative to the vibration node, and wherein the third vibration sensor is arranged in the region of the vibration node,
wherein the first vibration sensor and the second vibration sensor are arranged in particular symmetrically with respect to the plane of symmetry,
wherein the method comprises the following method steps:
determining an attenuation of the measuring tube vibrations,
measuring a first measurement variable by means of the measurement signals from the first vibration sensor and from the third vibration sensor,
measuring a second measurement variable by means of the measurement signals from the second vibration sensor and from the third vibration sensor,
determining an influence of the attenuation on the first measurement variable and on the second measurement variable,
forming differences between measured values of the first measurement variable and measured values of the second measurement variable, so that an influence of the mass flow on the differences is canceled out,
checking a correspondence between the difference and the attenuation.

14. The method according to claim 13,
wherein a type of interference is determined in the case of non-correspondence,
wherein the presence of a deviation of an asymmetry of measurement signals from the vibration sensors from a reference value of the asymmetry is checked, wherein the check takes into account amplitudes of the measurement signals.

15. The method according to claim 14,
wherein, when the deviation is present, a mass flow measurement is supported by an undisturbed pair of vibration sensors.

16. The method according to claim 15,
wherein the influence of the attenuation on measured values of the undisturbed first measurement variable or second measurement variable is corrected.

17. The method according to claim 16,
wherein, when determining the disturbed vibration sensor, a measurement signal amplitude of the third vibration sensor is used to determine a plausibility of a measurement signal amplitude of the first vibration sensor and a measurement signal amplitude of the second vibration sensor.

18. The method according to any of claim 17,
wherein, when the reference value of the deviation is present, a reduction in efficiency of the vibration exciter or of the vibration sensor is established from a measure of a non-correspondence between the difference and the attenuation.

19. The method according to claim 13,
wherein the attenuation is determined by a ratio of the excitation current of the vibration exciter to the specific vibration amplitude of a vibration sensor.

20. The method according to claim 13,
wherein the first measurement variable and the second measurement variable are each a phase difference or a measurement variable derived therefrom, such as a time difference or mass flow.

21. The method according to claim 20,
wherein, if the deviation has a time constant less than one month and in particular less than one week, the interference is interpreted as being caused by an external magnetic field in the region of a vibration sensor.

22. The method according to claim 13,
wherein the vibration sensors and the vibration exciter each have a magnet system and a coil system, which magnet system and coil system are movable relative to one another in parallel with a vibration direction.

23. The method according to claim 13,
wherein the Coriolis measuring device has an electronic measuring/operating circuit which operates the vibration exciter, evaluates measurement signals from the vibration sensors, carries out method steps, and calculates and provides measured values of measurement variables of the Coriolis measuring device.

24. The method according to claim 13,
wherein, if the differences of measured values of the first measurement variable and measured values of the second measurement variable deviate from an expected value for the difference between measured values of the first measurement variable and measured values of the second measurement variable a warning message is output.
